(19) United States
(12) Patent Application Publication
(10) Pub. No.: US 2009/0119329 A1
(43) Pub. Date: May 7, 2009

(54) SYSTEM AND METHOD FOR PROVIDING VISIBILITY FOR DYNAMIC WEBPAGES

(76) Inventors: Thomas C. KWON, Paramus, NJ (US); Michael Hanna, Washington, DC (US); Viktor A. Svirnovskiy, Jackson Heights, NY (US)

Correspondence Address: KENYON & KENYON LLP, ONE BROADWAY, NEW YORK, NY, 10004, US

(21) Appl. No.: 12/021,892

(22) Filed: Jan. 29, 2008

Related U.S. Application Data
(60) Provisional application No. 61/001,600, filed on Nov. 2, 2007.

(51) Int. Cl. G06F 17/30

(52) U.S. Cl. 707/102; 707/E17.002; 707/E17.107

(57) ABSTRACT

A system and method for providing visibility to dynamic webpages may include a static content database and a processor configured to, responsive to a request from a terminal for a dynamic webpage: generate the dynamic webpage; provide a static copy of the dynamic webpage for storage in the static content database; and transmit the dynamic webpage to the terminal. The processor is further configured to provide the static copy of the dynamic webpage to a webcrawler.

### CROSS-REFERENCE TO RELATED APPLICATIONS

This application claims priority to U.S. Provisional Application No. 61/001,600, filed Nov. 2, 2007, which is incorporated herein by reference in its entirety.

### FIELD OF THE INVENTION

The present invention relates to a system and method that provides visibility of dynamic webpages, e.g., by providing a form of the webpages for traversal by a web crawler.

### BACKGROUND INFORMATION

Web servers provide static and dynamic webpages, for example, for access by a user terminal running a web browser. Static webpages are those pages which, in response to requests from the user terminal, provide fixed content, for example, fixed text, links to other pages, and embedded pointers to files, which are retrieved and transmitted to the user terminal for reproduction of the webpages with the referenced files embedded within the webpages. In contrast, dynamic webpages are those pages which, in response to requests under different contexts or conditions, provide different contents which are dynamically generated, for example, by searching and retrieving content data from a database, for example, maintained by or linked to a web server. Furthermore, since the content data stored in the database may be updated periodically according to external information sources, a dynamic webpage may supply different webpages to the user terminal even under the same conditions at different times.

Web crawlers are programs which automatically traverse and index webpages so that they may be returned by a web browser as results obtained from a web search engine. For example, in response to a keyword search, a web search engine may produce a list of links to webpages that are relevant to the keyword, and therefore provide visibility to these webpages. However, web crawlers are generally configured so that they traverse only static webpages and not dynamic webpages. One reason for such restriction is that the web crawlers may become “lost” within the enormous amount of data of databases based on which dynamic webpages may be generated, and may even be “trapped” by a loop of webpage links within the same dynamic webpage, without having a way to escape to traverse and index other webpages.

Since web crawlers generally do not index dynamic webpages, the dynamic webpages may be in an almost invisible state, in which they are not returned by web browsers as search engine results. Therefore, they can be accessed only by directly inputting an address, for example, a Uniform Resource Locator (URL) address, of the dynamic webpage, or through links, e.g., embedded in other webpages. Inclusion of a website in search engine results often determines to a large extent the amount of traffic, and consequently the revenues, that the website may generate. Accordingly, it is important to develop a system and method that provides visibility for dynamic webpages and that promotes their return as search engine results.

### SUMMARY

Exemplary embodiments of the present invention provide a system and method that provides dynamic webpages with increased visibility, e.g., so that they may be provided as results of a web browser search. An interceptor module may obtain a copy of dynamic webpages as they are generated at the web server and returned in response to a request therefor, e.g., in response to input of the URLs of the dynamic webpages in a web browser application. The copy of the dynamic webpages may be stored as static versions of the corresponding dynamic webpages in a static webpage store. The static versions of the corresponding dynamic webpages may be suitable for traversal by web crawlers. The static webpage store may index the static pages and provide the index in any conventional manner to a web crawler for the web crawler to traverse.

In an example embodiment of the present invention, a system for providing visibility of a dynamic webpage to a search engine may include a web server and a static webpage store. The web server may further include a webpage generator that is configured to dynamically generate a webpage, e.g., in response to a user request therefor, based on data from a first content database; and a webpage interceptor module that is configured to capture a first version of webpage data relating to the webpage. The static webpage store may be configured to convert the first version of webpage data from the web server into a second version of webpage data suitable for a search engine search. The web server may further include a webpage logger that is configured to record activities of the webpage interceptor module and the webpage generator. In response to the user request, the webpage generator may request the data from the first content database for generating the dynamic webpage.

In an example embodiment of the present invention, the webpage interceptor module is a plug-in to the web server which is capable of providing the first version of webpage data to the static webpage store. The webpage interceptor module may further include a temporary cache for storing the first version of webpage data in the web server. The temporary cache may then transmit the first version of webpage data to the static webpage store according to a schedule.

In an example embodiment of the present invention, a second content database may store the second version of the webpage data. The static webpage store may access and update the second content database. The static webpage store may further include a webpage index generator that is configured to create an index of the content of the second content database, and a webpage redirector that is configured to redirect a user request for a webpage corresponding to the second version of the webpage data from the static webpage store to the web server. In an alternative embodiment of the present invention, in response to the user request, the static webpage store may transmit a webpage based on the second version of the webpage data stored in the second content database directly to the user.

The second version of the webpage data may include keywords and optimized data derived from the first version of webpage data.

In an example embodiment of the present invention, a method for providing visibility of a dynamic webpage may include: intercepting, by a webpage interceptor module of a web server, a request for a webpage; requesting, by the webpage interceptor module, the webpage from a webpage generator of the web server in response to receipt of the intercepted request; determining whether the requested webpage is stored in a temporary cache; storing in the temporary cache a first version of webpage data relating to the webpage if it is determined that the webpage does not exist in the temporary cache; transmitting the first version of webpage data to a static webpage store according to a schedule; and converting the first version of webpage data into a second version of webpage data suitable for a search engine search.

In an example embodiment of the present invention, the method may further include: based on a condition of the static webpage store, traversing by an internal web crawler a website that provides the dynamic webpage to generate an initial first version of webpage data and an initial second version of webpage data in the static webpage store. In an example embodiment, the condition is that the static content database is void of static webpage content, in which case, it may be advantageous to run an internal web crawler to provide initial visibility to the web site.

In an example embodiment of the present invention, the method may further include recording activities of the webpage interceptor module and the webpage generator in a logger module residing in the web server, e.g., for archiving and debugging purposes.

In an example embodiment, the method may further include transmitting the webpage generated from the generator to a user terminal.

In an example embodiment, the method may further include: redirecting to the web server a request for a webpage addressed to the static webpage store. In an alternative embodiment, the method may include, in response to the request, providing to a user terminal that is the source of the request a static webpage based on information stored in the second content database.

In an example embodiment of the present invention, the static webpage store may be implemented as a dedicated appliance computer, e.g., a headless Linux server physically located within a data center with high speed local connection to the web server, which performs all optimization and filtering tasks on data extracted from the system's web server. The static webpage store may include, for example, a single dual-core Central Processing Unit (CPU), 4 GB of memory, 500 GB hard disk drive (“HDD”) with RAID 5 configuration option. In an example embodiment, a kernel for the headless Linux server is a custom monolithic Linux kernel based on SUSE Linux 10 or a later version. The Linux system kernel may be provided, for example, in a non-modular manner. The static content database may be implemented using an Oracle database management system, while the temporary cache may be implemented in a file storage on a separate partition in a hard disk drive. In a preferred embodiment, the Oracle database may be configured in multithreaded mode to allow proper memory distribution between connection pools, and to have a “cold” backup option enabled and scheduled to be executed once a day. The embodiment has the advantages over a simple stand-alone plug-in because the majority of work using CPU power may be offloaded to the static webpage store without adversely affecting the server performance, data may be stored in the static webpage store without adversely affecting the sever storage, and the static webpage store may provide flexibility for future expansion when new load balancing and storage options are available for the static webpage store without requiring changes or downtime to the web server.

In an example embodiment of the present invention, the web server plug-in, which may include the webpage interceptor module, may be implemented in the highest performance development language for the target platform, for example, in most cases using C++, or alternatively, using Java or other programming languages for certain platforms under certain situations. In an example embodiment, the web server plug-in may be compiled as a module for Apache or similar web servers with loadable module support, preferably an Apache 2.0 or a later version, or other UNIX based web/application server with the capability of loading modules of similar functionalities. Alternatively, for Internet Information Services (“IIS”) web servers, e.g., a Microsoft IIS 6.0 or a later version, the web server plug-in may be compiled as an Internet Server Application Programming Interface (“ISAPI”) extension. In an example embodiment, the web server plug-in may fully support multithreading. A temporary cache for the web server plug-in may be optionally set to local cache memory for the highest performance, or local database or file-based storage for most platforms, or in-memory volatile storage for special platform support. In a preferred embodiment, the web server plug-in supports Unicode content for all data.

In an example embodiment of the present invention, after traversal by the web crawler of the static versions of the dynamic webpages, pointers to the static webpages may be provided as results to web browser searches. In response to selection of a pointer to a static version of the dynamic webpage, the web browser may request the static version of the dynamic webpage from the static page store.

In an example embodiment of the present invention, responsive to the request for the static version of the webpage, the static page store may redirect the web browser to the dynamic webpage server, where the redirection requests the dynamic webpage corresponding to the requested static version of the webpage.

The dynamic webpage server may return the dynamic webpage to the requesting web browser for display at the user terminal. The redirection may be advantageous since it may facilitate updates to the static page store and return up-to-date versions of the dynamic webpage to the requesting user terminal.

The interceptor module may obtain a copy of the newly generated dynamic webpage generated in response to the redirection. If the newly generated dynamic webpage substantively differs from the static version of the dynamic webpage previously stored in the temporary cache, e.g., where the database data used for generation of the dynamic webpage has changed, the interceptor module may replace in the static webpage store the previous static version of the webpage with the copy of the newly generated dynamic webpage as a new static version of the webpage, since the differences may indicate that the previously stored static version of the webpage is outdated.

If upon redirection, an error or NULL is returned, it may be determined that the dynamic webpage is no longer available. The system and method of the present invention may accordingly delete the static version of the webpage from the static webpage store.

In an alternative example embodiment of the present invention, responsive to the request for the static version of the webpage, the static webpage store may return the static version of the webpage. The return of the static webpages may be advantageous, e.g., so as to comply with network safety and/or security rules, which may require return of requested pages. It may occur that outdated versions of the webpage and obsolete webpages are returned, since the static version of the webpage might not accurately reflect updates to the dynamic webpages or the database data used for generation of the dynamic webpage to which the static webpage version corresponds. Instead, updates to or deletions of the static page versions may be implemented in response to generation of a dynamic webpage or return of an error or NULL in response to a direct request to the dynamic webpage server for the corresponding dynamic webpages, e.g., where the URLs of the corresponding dynamic webpages are entered. In one example variant of this embodiment, the system and method may periodically request dynamic versions of the stored static webpages to determine whether the stored static webpages are current.

In an example embodiment of the present invention, the system may additionally include a management module including a client GUI and an administrative GUI, a reporting module, an internal crawler module, a pay-per-click module, a pay-per-action module, and a magic keyword module. The client GUI may be provided for installers and clients who use the system to set attributes for the other modules in the system. For example, based on assigned rights, the client GUI may provide access to a configuration panel with the capabilities of managing default application settings and specifying data transparency rules for all or any sections of a webpage. The administrative GUI may be adapted for setting system critical settings and monitoring confidential portions of the system functions (including functions related to revenue stream). For example, based on assigned rights, the administrative GUI may provide access to a configuration panel with capabilities of system archiving, backup/restore, system cleanup, user management, resetting all settings to default, accessing reports, and a configuration panel (e.g., the same as the client GUI).

The reporting module may allow viewing and reporting of the content in the logger, e.g., text based recording of errors and activities for the webpage interceptor module and the webpage generator. The reporting module may also report on general system statistics relating to the health and function of the static webpage store, including, e.g., system load and disk usage. The reporting module may be capable of providing information on keywords, search engine activities, and number of requests, specifically including: content processing statistics, e.g., errors and logs, content processing time, number of processed files, redirect statistics, e.g., successes/failures, average speed of redirections, system internal logs, archiving/history errors/success logs, backup logs, system failure logs, and access information log on administrators/editors activity.

In an example embodiment of the present invention, once installed, the static webpage store may function autonomously to obtain and optimize data in small scheduled increments so as not to overload the system. When first installed, the system may be in a state with no data and may require some time to begin building optimized content. To speed up, an internal crawler module, e.g., which limits its crawling to the website that is the source for the dynamic webpage, may run once during the first installation or after major site redesigns to traverse the static webpage portions of the website so as to quickly populate the system with some of the client's website structure and data.

In an example embodiment of the present invention, a pay-per-click module may keep track of all distinct redirects that pass through the static webpage store for the purpose of client billings related to redirects, in accordance with a common industry standard method of billing clients based on the amount of system usage.

In an example embodiment of the present invention, a pay-per-action module may include functionalities similar to the pay-per-click module. In addition, the pay-per-action module may track purchases made by consumers that have arrived on product pages by way of the static webpage store. A key measurement of this performance may be sales rather than clicks. The pay-per-action module may be implemented for large transaction based e-commerce systems where pay for performance is the desired method of billing, which is a common industry standard method of billing clients based directly on the amount of sales.

In an example embodiment of the present invention, as an additional value added to the overall solution, a magic keyword module may be included in the static webpage store. This module may store and categorize keywords used in search engines by users to find the client's webpages. These keywords may be captured from users arriving at the client's web pages by way of any search engine. All keywords may be stored in association with the webpage(s) that they are used to access (by incoming links). The keywords may then be used, e.g., for two advanced services: 1. to automatically build new keyword lists from industry specific thesauruses; and 2. to use both original and thesaurus generated keywords to automatically build meta-tags and additional content (copy, abstracts, etc.) for the purpose of fortifying relevancy of overall web page content.

### BRIEF DESCRIPTION OF THE DRAWINGS

FIG. 1 is a diagram that illustrates a system for providing visibility to dynamic webpages, according to an example embodiment of the present invention.

FIG. 2 is a cross-functional flowchart that illustrates a method of providing visibility to dynamically generated webpages, according to an example embodiment of the present invention.

FIG. 3 is a cross-functional flowchart that illustrates a method of accessing a dynamic webpage through a webpage storage appliance, according to an example embodiment of the present invention.

### DETAILED DESCRIPTION OF EXAMPLE EMBODIMENTS

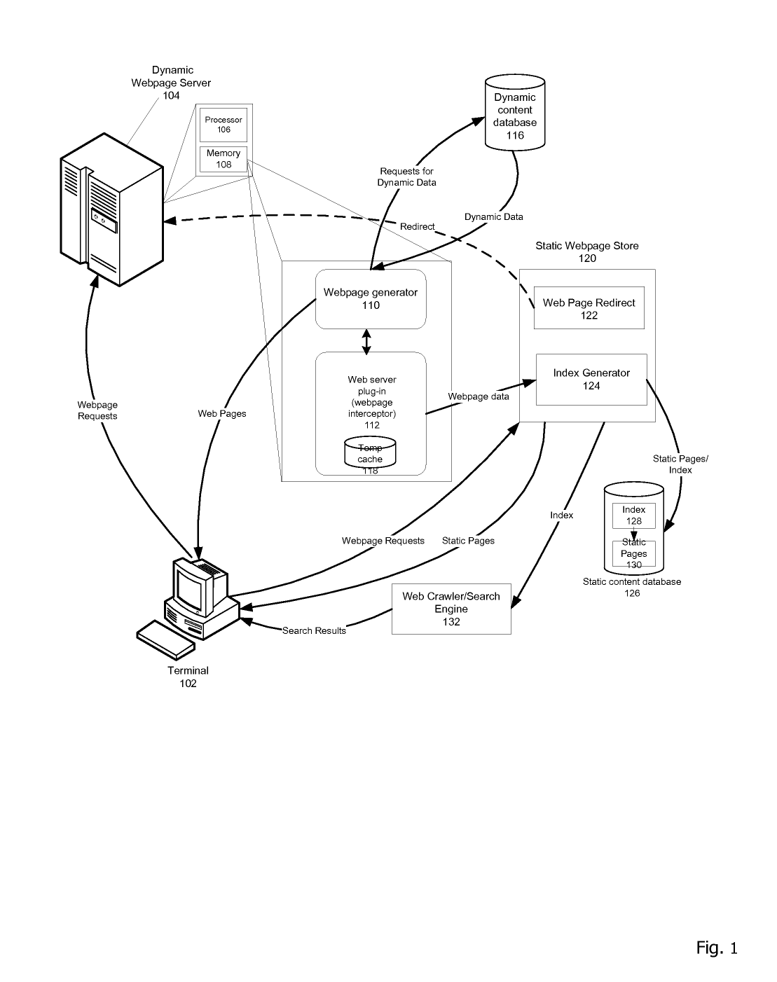

FIG. 1 illustrates a system that provides visibility of dynamic webpages to search engines according to an example embodiment of the present invention. A terminal 102 may send webpage requests to a dynamic webpage server 104 which may include a processor 106 to execute program instructions stored in a memory 108, e.g., a hardware-implemented computer-readable medium, for handling the requests. Receipt of the requests may trigger dynamic webpage generation routines including execution of programs including extensions. The request may initially be handled by a web server plug-in, also referred to herein as a webpage interceptor 112. The webpage interceptor 112 may be implemented as an extension, for example, as an Internet Server Application Programming Interface (“ISAPI”) extension that runs on an Internet Information Services (“IIS”) server. The interceptor 112 may record the request and forward it to a webpage generator 110. The webpage generator 110 may access a dynamic data database 116 stored, for example, in the memory or in an external memory, to retrieve dynamic data with which to generate the requested dynamic webpage. The webpage generator 110 may return the requested dynamic webpage to the requesting terminal 102 via input/output ports. The webpage generator 110 may also provide a copy of the generated page to the interceptor 112 and the interceptor 112 may provide the copy of the generated page as a webpage to be statically stored in a temporary cache 118. In an example embodiment of the present invention, the interceptor 112 may also capture hidden “back-end” information along with the statically stored webpage, e.g., session and variables of the page, to be stored in the temporary cache 118. The hidden “back-end” information may be used for redirection of a static webpage request for requesting a dynamic webpage, as described in detail below. The temporary cache 118 may be a memory, a file, and/or a database residing in a hard drive. The temporary cache 118 may transmit the statically stored webpage along with hidden “back-end” information, together referred to herein as webpage data, to a static webpage store 120, for example, according to a schedule, e.g., each night when the load on the network is relatively low. Alternatively, the interceptor 112 may provide the webpage data directly a static webpage store 120, e.g., depending on a configuration set via the administrative control panel GUI.

The static webpage store 120, which may be integrated with the dynamic webpage server 104 or implemented on a separate device, e.g., maintained by a host server which services many clients, each client having a corresponding dynamic webpage server, may include an index generator 124. In an example embodiment of the present invention, the static webpage store 120 may be a dedicated appliance computer co-located with the web server 104 and connected to the web server 104 with a high speed connection for better performance. The static webpage store 120 may include a processing module which may transform the data obtained from the webpage interceptor 112. For example, the processing module may clean the webpage by removing all useless content and tags including Hyper Text Markup Language (“HTML”)/Cascading Style Sheet (“CSS”)/Java Script format, while preserving needed information, including meta- and transaction data, e.g., page title, page body, page date, content size, description, keywords, URL, URL parameters, post information, requested information, and page content data, e.g., article titles, article bodies, file names, file descriptions and links, and link descriptions. Further, the processing module may, in an optimization step, convert the cleaned webpage into a special format, e.g., organized in terms of meta-, transaction, and content data. In an example embodiment of the present invention, the transformation may be based on transformation rules which may be configured via an Administration Control Panel GUI.

Transformation rules may be used to automatically generate Extensible Style Language Transformation (“XSLT”) templates for parsing contents and performing transformations. The predefined transformation may remove useless formatting information, store all meta- and transaction data in a meta content storage and the page content data in a XML storage. An HTML generator may generate a static page based on the meta content data and the page content data for storing in the static content database.

An index generator 124, e.g., implemented as a set of instructions stored in a hardware-implemented computer-readable medium and executable by a processor of the webpage store 120, may store and index the static pages in a static content database 126. Since many static webpages may be stored, the static webpage store 120 may provide the index to a web crawler/search engine 132 which may traverse the static webpages referenced by the index for inclusion in an index maintained by the web crawler 132 and used for the search engine to provide results to a web browser running on a terminal 102. (It is noted that a single web crawler may service multiple search engines. However, for clarity, a single web crawler/search engine 132 is described.) The described features may facilitate automatically providing visibility of dynamic webpages to a web crawler so that data corresponding to the dynamic webpages may be provided as results of a search engine search.

Subsequent to the inclusion of a reference to one of the static pages 130 in the index of the web crawler/search engine 132, a link pointing to the static page 130 may be provided as a search result by search engine component of the web crawler/search engine 132. In response to selection of the search result, e.g., by clicking the link, a corresponding request for the static webpage 130 may be transmitted from the terminal 102 to the static webpage store 120, which may directly return the requested static webpage 130 to the terminal 102.

In an alternative example embodiment of the present invention, the static webpage store 120 may include a webpage redirect 122, e.g., implemented as a set of instructions stored in a hardware-implemented computer-readable medium and executable by the processor of the static webpage store 120, which may redirect the request for the static webpage 130 to the dynamic webpage server 104, represented by the dashed line in FIG. 1. The webpage redirect 122 may determine the dynamic webpage to which the requested static page 130 corresponds and send the request by the terminal 102 to the dynamic webpage server 104 for handling by the generator module 110, interceptor module 112, and logger module to return the corresponding dynamic webpage. The request for the dynamic webpage may be handled as described above. The handling of the request may cause the interceptor 112 to update the static webpage store 120 to include an updated version of the static webpage.

In an example embodiment of the present invention, when the interceptor 112 handles a dynamic webpage request, the interceptor 112 may determine whether the temporary cache 118 already includes a copy of the dynamic webpage. When the cache 118 already includes a static copy of the webpage, the interceptor 112 may refrain from forwarding the static copy to the static webpage store 120 unless the interceptor 112 determines that the newly generated static webpage copy differs substantively from the cached copy, in which case the interceptor 112 may replace the copy previously stored in the cache 118 with the current copy and forward the new copy to the static webpage store 120 immediately or during a batch processing as discussed above, to replace the previously stored static version of the dynamic webpage at the static webpage store 120. In an example embodiment, the system may examine the attributes of the response, e.g., data generated for transmission to the user's browser, to determine whether the data is a duplicate of that already stored in cache. The system may be configurable as to which attributes may be considered significant for the duplicity determination. For example, for some users, URL and query strings may be considered significant in determining the similarity or differences between the newly generated webpage and the webpage data in cache. Other users may consider additional or other attributes, e.g., response size and request type, or any other types of attributes of a webpage response.

In an example embodiment of the present invention, the cache content may be cleared according to an age limit, i.e., a limit on how long the cache content may be stored in the cache. The age limit may be set using a GUI for the web server plug-in. Records of cache content may be presumed to have been processed by the static store if the records are over the age limit, and therefore, cache storage for the cache content over the age limit may no longer be necessary. Further, records of the cache which are over the age limit may often be outdated and poorly reflect a current status of the data or pages to be provided, so that clearing of the records over the age limit from cache may be more efficient that performance of the duplicity determination for each of the records over the age limit.

In an example embodiment of the present invention, the system and method may provide for an initial stage to be executed when initially installing the interceptor plug-in. During the initial stage, a crawler module for running an internal web crawler may be executed for traversing any static portions of the website that provides the dynamic webpages. The static portions may include, e.g., templates and/or static webpages. The internal crawler may generate an initial static page index of the results of the initial crawl and provide the index to the web crawler. This may provide some initial visibility so that a user may be led to the website, navigate the website, and request dynamic webpages, in response to which the above-described methods of providing visibility to the dynamic webpages may be performed. Alternatively, a user familiar with the website, e.g., the website owner or creator or customer who has viewed an advertisement, may initially access pages after installation of the plug-in by manually typing in the addresses of the dynamic webpages.

In an example embodiment of the present invention, the static pages provided to the web crawler may be stripped down to just their text. The file may include pointers to other files, e.g., picture or applet files, which may be provided when requested by the web browser according to the embodiment in which static webpages are returned.

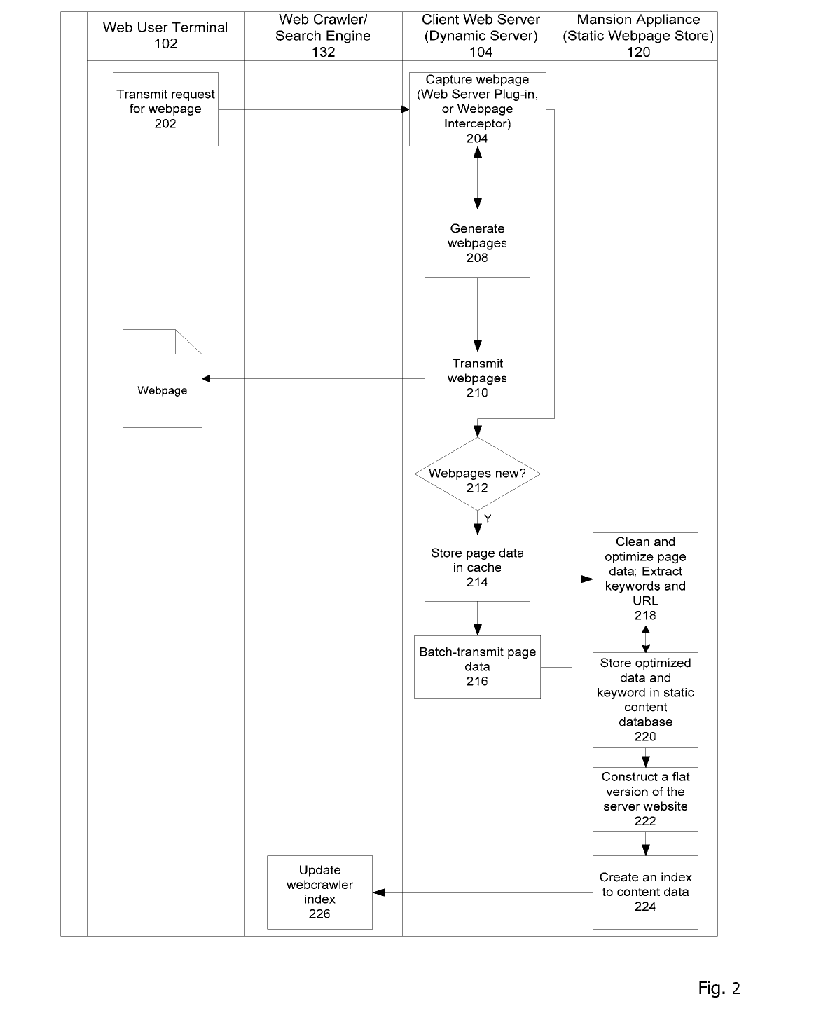

FIG. 2 illustrates a method that provides visibility of dynamic webpages to search engines according to an example embodiment of the present invention. At step 202, the user terminal 102 may transmit to the client web server 104 a request for a dynamic webpage. At step 204, a web server plug-in/webpage interceptor 112 of the web server 104, may forward the request to a webpage generator 110 which may generate the requested dynamic webpage and, at 210, transmit the generated webpage to the user terminal 102. The webpage interceptor 112 may also receive a copy of the generated webpage and, at 214, store the copy in a temporary cache 118. The activities of the webpage interceptor 112 and the web server 104 may be logged in a page logger, e.g., for archiving and debugging purposes.

In an example variant of the embodiment, before storing the webpage copy in the cache, the webpage interceptor 112 may, at 212, determine whether the cache already includes a webpage copy that corresponds to the same dynamic webpage to which the new webpage copy corresponds. If a match is found, the webpage interceptor 112 may compare the two copies. If it is determined that the cache does not already include a corresponding copy or that the new copy is substantially dissimilar to a corresponding copy, the webpage interceptor 112 may store the newer and non-duplicated page in the temporary cache 118 or directly transmit it to the static webpage store 120 to replace the older version of the page. Otherwise, the interceptor 112 may exit the process without re-storing or resending the webpage copy for efficiency, e.g., with respect to bandwidth and/or CPU power.

The webpage interceptor 112 may transmit the generated webpage data (the content of the webpage along with “backend” data) directly to the static webpage store 120, or in an alternative example embodiment, store the generated webpage data in the temporary cache 118 so that it may be batch-transmitted, at 216, to the static webpage store 120, e.g., according to a schedule, for example, each night when the load of the network is relatively low.

In an example embodiment of the present invention, the static webpage store 120 may further process the received webpage data to transform the webpage data into a format that is suitable for a search engine or webcrawler. For example, at 218, the webpage data may be processed through a filtering procedure to clean and optimize the data by removing all useless content and tags, and at the same time, preserving information needed for further optimization. This may be achieved by a set of transformation rules which may be configured, for example, via an Administration Control Panel GUI (not showing in the figures) to transform the webpage data into more manageable forms. At 218, predefined transformations may remove HTML, CSS, or Java scripts. At the same time, the transformation may preserve metadata and transaction data including, for example, page title, page body, page date, content size, description, keywords, Uniform Resource Locator (URL), URL parameters, post information, and request information, and store them in a content database. The static webpage store 120 may also, at 220, extract keywords from the webpage data and store them in the static content database. Based on the information in the static content database, an HTML page generator may, at 222, run an independent process to generate crawler-friendly versions of the webpage copies and an index page containing a sitemap of all pages within the client website with a short description, for example, a paragraph length synopsis, of each page's content. The index may be created, for example, according to a schedule, usually once each night when overall loads on both the web server and the static webpage store are the lowest. In an alternative embodiment, an administrator may initiate the indexing process using the Administrative Control Panel GUI, for example, in initial installation or for situations when large quantities of website content have been changed.

At 224, the static webpage store 120 may make its internal static webpage index available for traversal by the web crawler, so that the web crawler may, at 226, update its webpage index.

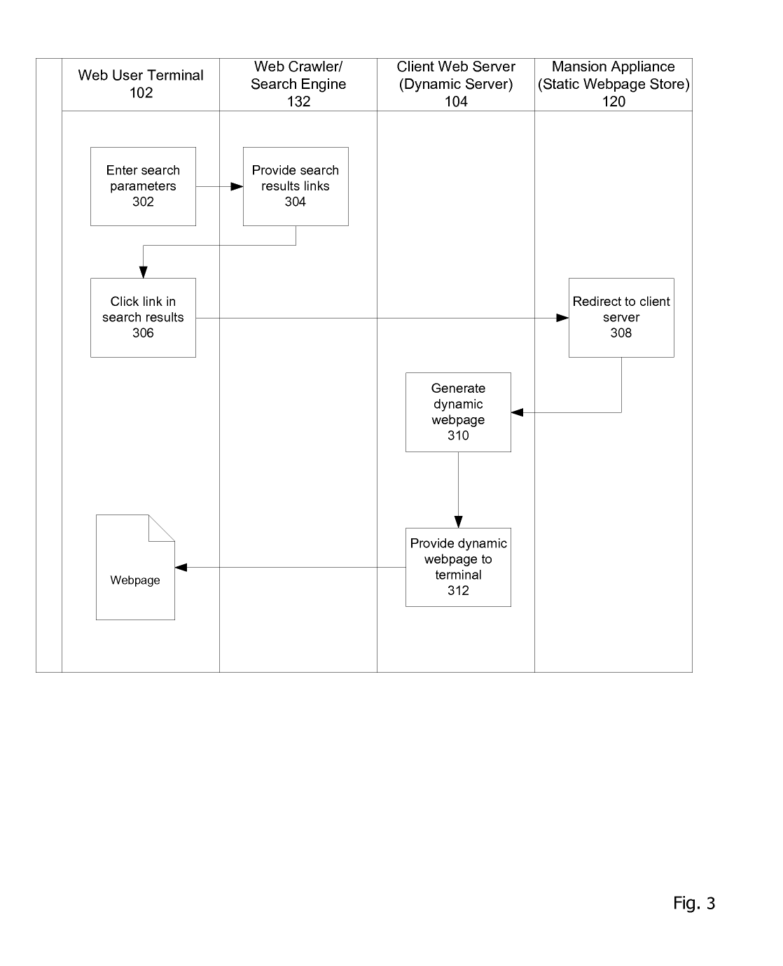

FIG. 3 illustrates a method for providing a webpage in response to a request by the terminal 102 and addressed to the static webpage store 120, according to an example embodiment of the present invention. A search engine, after traversal by the web crawler of the static versions of the dynamic webpages in the static webpage store 120, may provide as search results links to the static webpages stored by the static webpage store 120. At step 302, search parameters may be entered at the user terminal 102. At 304, the search engine may return search result links which may include links to the static webpages of the static webpage store 120. At 306, a user operating the terminal 102 may click a link of the search results to a static webpage of the static webpage store 120, which may cause transmission to the static webpage store 120 of a request for the static webpage.

At step 308, responsive to the request, the static webpage store may redirect the request to the client dynamic webpage server 104. In response to the redirected request, the dynamic webpage server 104 may, at step 310, generate a dynamic webpage. The webpage interceptor may then capture the generated dynamic page and accordingly update the temporary cache 118, and the static webpage store 120, as described above. At step 312, the dynamic webpage server 104 may transmit the dynamic webpage to the user terminal 102.

Those skilled in the art can appreciate from the foregoing description that the present invention may be implemented in a variety of forms, including, for example, variations of the sequence of the steps shown in FIGS. 2 and 3, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A system for providing visibility to dynamic webpages, comprising:
a static content database; and
a processor of a web server configured to:
responsive to a request from a terminal for a dynamic webpage:
generate the dynamic webpage;
provide a static copy of the dynamic webpage for storage in the static content database; and
transmit the dynamic webpage to the terminal; and
provide the static copy of the dynamic webpage to a webcrawler.

2. The system of claim 1, further comprising:
a dynamic content database, wherein:
responsive to the request, the processor obtains content from the dynamic content database; and
the dynamic webpage is generated based on the obtained content.

3. The system of claim 1, wherein, for providing the static copy for storage in the static content database, the processor executes a webpage interceptor plug-in to be used by the web server during generation of the dynamic webpage.

4. The system of claim 1, wherein:
providing the static copy for storage in the static content database includes generating the copy by converting a replica of the dynamic webpage into the static copy; and
the static copy is in a format suitable for traversal by the webcrawler.

5. The system of claim 4, wherein converting the replica of the dynamic webpage includes:
removing formatting script codes embedded in the replica of the dynamic webpage; and
separately storing metadata and transaction data embedded in the replica of the dynamic webpage in a meta content storage and page content data embedded in the replica of the dynamic webpage in a page content storage.

6. The system of claim 4, further comprising:
a temporary cache for storing the replica, wherein for storing the static copy in the static content database, contents of the temporary cache are provided to the static content database according to a schedule.

7. The system of claim 1, wherein the processor is configured to execute a Hyper Text Markup Language (HTML) page generator module to generate the static copy based on metadata, transaction data, and page content data of the dynamic webpage.

8. The system of claim 1, wherein:
the processor is configured to generate an index of a plurality of static webpage copies stored in the static content database, including the static copy stored responsive to the request; and
providing the static copy of the dynamic webpage to the webcrawler includes providing the index to the webcrawler for traversal of the plurality of static webpage copies referenced by the index.

9. The system of claim 1, wherein the processor is configured to, in response to a request for the static copy, redirect the request as a request for the dynamic webpage.

10. The system of claim 1, wherein the processor is configured to, in response to a request from a terminal for the static copy, transmit the static copy to the terminal.

11. The system of claim 1, wherein:
the web server includes:
a client server; and
an appliance server which is connected to the client server and with which the static content database is integrated;
the processor includes:
a first processor located in the client server which, responsive to webpage requests, generates dynamic webpages; and
a second processor located in the appliance server; and
the second processor is configured to, responsive to a static webpage request from a terminal and which is addressed to the appliance server, redirect the request from the appliance server to the client server for the first processor to generate and transmit to the terminal a dynamic webpage corresponding to the requested static webpage.

12. A method for providing visibility to dynamic webpages, comprising:
responsive to a request from a terminal for a dynamic webpage:
generating the dynamic webpage;
providing a static copy of the dynamic webpage for storage in a static content database; and
transmitting the dynamic webpage to the terminal; and
providing the static copy of the dynamic webpage to a webcrawler.

13. The method of claim 12, further comprising:
responsive to the request, a processor obtaining content from a dynamic content database;
wherein the dynamic webpage is generated based on the obtained content.

14. The method of claim 12, wherein, providing the static copy for storage in the static content database includes executing a webpage interceptor plug-in for the generation of the dynamic webpage.

15. The method of claim 12, wherein:
providing the static copy for storage in the static content database includes generating the copy by converting a replica of the dynamic webpage into the static copy; and
the static copy is in a format suitable for traversal by the webcrawler.

16. The method of claim 15, wherein converting the replica of the dynamic webpage includes:
removing formatting script codes embedded in the replica of the dynamic webpage; and
separately storing metadata and transaction data embedded in the replica of the dynamic webpage in a meta content storage and page content data embedded in the replica of the dynamic webpage in a page content storage.

17. The method of claim 15, further comprising:
storing the replica in a temporary cache, wherein providing the static copy for storage in the static content database includes providing contents of the temporary cache to the static content database according to a schedule.

18. The method of claim 12, further comprising:
generating the static copy based on the metadata, transaction data, and page content data of the dynamic webpage.

19. The method of claim 12, further comprising:
generating an index of a plurality of static webpage copies stored in the static content database, including the static copy provided for storage responsive to the request;
wherein providing the static copy of the dynamic webpage to the webcrawler includes providing the index to the webcrawler for traversal of the plurality of static webpage copies referenced by the index.

20. The method of claim 12, further comprising:
in response to a request for the static copy, redirecting the request as a request for the dynamic webpage.

21. The method of claim 12, wherein:
a first processor located in a client server generates dynamic webpages in response to webpage requests, the method further comprising:
a second processor located in an appliance server which is connected to the client server and with which the appliance server is integrated, responsive to a static webpage request from a terminal and which is addressed to the appliance server, redirecting the request from the appliance server to the client server for the first processor to generate and transmit to the terminal a dynamic webpage corresponding to the requested static webpage.

22. A computer-readable medium having stored thereon instructions, the instructions which, when executed, cause a processor to perform a method for providing visibility to dynamic webpages, the method comprising:
responsive to a request from a terminal for a dynamic webpage:
generating the dynamic webpage;
providing a static copy of the dynamic webpage for storage in a static content database; and
transmitting the dynamic webpage to the terminal; and
providing the static copy of the dynamic webpage to a webcrawler.
